(19) United States
(12) Patent Application Publication
(10) Pub. No.: US 2015/0069648 A1
(43) Pub. Date: Mar. 12, 2015

(54) DOUGH THICKNESS GUIDES AND RELATED METHOD

(71) Applicant: Clive Baillie, Hollywood, CA (US)

(72) Inventor: Clive Baillie, Hollywood, CA (US)

(21) Appl. No.: 14/479,567

(22) Filed: Sep. 8, 2014

Related U.S. Application Data
(60) Provisional application No. 61/875,224, filed on Sep. 9, 2013.

(51) Int. Cl. G01B 5/06; A21C 3/02

(52) U.S. Cl. CPC G01B 5/06; A21C 3/021
USPC 264/40.1; 33/562

(57) ABSTRACT

A kitchen tool in the form of one or more pairs of dough thickness guides used to roll out pastry, cookie dough, fondant and other doughs to a desired uniform thickness. At least a pair of guides having the same thickness or depth are spaced apart from one another less than a length of a rolling pin. The dough is rolled by the rolling pin until the rolling pin contacts the spaced apart guides, wherein the dough has been rolled evenly to the desired thickness.

### RELATED APPLICATION

This application claims priority to U.S. provisional patent application Ser. No. 61/875,224, filed Sep. 9, 2013.

### BACKGROUND OF THE INVENTION

The present invention generally relates to baking. More particularly, the present invention relates to pastry dough thickness guides and the related method of using the same to create dough of a desired consistent thickness.

It is well known by bakers that in order to create evenly baked crusts and other pastries and the like, an even, consistent thickness of the precooked dough is essential. Uneven dough results in the thinner portions cooking more quickly than the thicker portions. This results in the thinner portions being either overcooked or the thicker portions being undercooked such that the pastry or crust or the like is not baked evenly.

Traditionally, when rolling out dough, the baker used intuition when it came to the thickness of the rolled out dough. Unless an expert baker, it has been found to be difficult to roll out dough to an exact thickness. Sometimes, the dough can be slightly thicker at one end compared to another. For example, the edges can be thinner as the rolling pin rolls off the edge of the rolled dough.

There exist dough roller appliances which are mechanical machines that roll the dough to a consistent and desired thickness. The dough is inserted into the appliance and fed through a set of rollers which are hand-actuated or rolled by an electric motor or the like. These appliances do provide a consistently uniform thickness of rolled dough. Such appliances can be fairly expensive and require a large amount of space to be operated and stored. As such, these appliances are typically used in the commercial setting and not in household settings, particularly of the average baker.

There exists an adjustable rolling pin, wherein rings of different diameter are secured to the outside ends of a rolling pin so as to raise the rolling pin to a desired height corresponding to the desired thickness of the dough. However, this adjustable rolling pin has drawbacks as well. Each time a dough is desired to be rolled out to a different thickness, a different pair of rings must be attached to the outside ends of the rolling pin. Furthermore, the baker must purchase the adjustable rolling pin and cannot use his or her own rolling pin(s).

Rolling pins come in a variety of sizes, shapes and materials. Common materials include wood, glass, ceramic, acrylic, Bakelite, copper, brass, aluminum, silicone, stainless steel, plastic and marble. Some are hollow and are able to be filled with cold or warm water to better roll a desired food. Marble rolling pins are often cooled in a refrigerator for maintaining a cold dough while making puff pastry. Rolling pins may consist of a relatively thick and heavy roller having thinner handles which extend through the roller. These are used by grasping the handles and pushing the pin across the dough to be rolled out. Other rolling pins comprise rods which are used by rolling the rod (without handles) across the dough using one's palm. In the case of the adjustable rolling pin, the desired size, type, or material of the rolling pin which the baker already owns may not be able to be used. Not only will purchasing the adjustable rolling pin provide a potentially unnecessary cost to the baker, the baker may not be able to use the rolling pin which is best suited for the particular type of dough and job to be performed.

Accordingly, there is a continuing need for tools and a method for creating dough of exactly the required thickness. Such tools and methods should be able to be used in connection with various different types of rolling pins and also in connection with different types of dough. Such tools should be capable of being used by any baker in a variety of settings, including residential settings. The present invention fulfills these needs, and provides other related advantages.

### SUMMARY OF THE INVENTION

The present invention is generally directed to dough thickness guides for manually rolling dough to a desired, consistent thickness. The guides comprise a plurality of elongated strips, each strip having a generally consistent thickness along an operating length thereof. Each elongated strip has opposing side edges of a predetermined thickness corresponding with the desired thickness of the rolled dough. For example, the elongated strips typically have a thickness of less than 0.5 inches. The elongated strips are typically less than two inches in width, and are between four and twenty-four inches in length.

The elongated strips each have a generally flat surface for contact with the supporting surface upon which the dough is to be rolled. An opposite upper surface of each elongated strip has a generally flat surface for contact with a rolling pin.

The plurality of elongated strips comprises a plurality of pairs of elongated strips having generally identical dimensions. The plurality of elongated strips is attachably connected to one another. For example, an aperture may be formed adjacent to an end of each elongated strip, and a clasp detachably connecting the elongated strips to one another.

In accordance with the method of the present invention of manually rolling dough to a predetermined, consistent thickness, a rolling pin is provided which has a length between opposing ends of the rolling pin. A pair of dough thickness guides is placed in spaced relation less than the length of the rolling pin. The dough thickness guides comprise elongated strips each having a thickness of the desired thickness of the rolled dough. The dough disposed between the dough thickness guides is manually rolled using the rolling pin until the rolling pin contacts an upper surface of each of the pair of dough thickness guides, at which time the dough has been rolled to the predetermined, consistent thickness.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side perspective view of a dough thickness guide embodying the present invention;

FIGS. 2A-2D are side perspective views of dough thickness guides of varying thickness, in accordance with the present invention;

FIG. 3 is a top view of a plurality of pairs of guides, used in accordance with the present invention;

FIG. 4 is a side perspective view of a plurality of pairs of dough thickness guides, detachably connected to one another;

FIG. 5 is a side perspective view similar to FIG. 4, but having a sleeve over a portion of the dough thickness guides;

FIGS. 6-9 are diagrammatic views illustrating the use of the dough thickness guides in manually rolling dough to a desired, consistent thickness, in accordance with the present invention.

### DETAILED DESCRIPTION OF THE PREFERRED EMBODIMENTS

As shown in the drawings, for purposes of illustration, the present invention is related to dough thickness guides and a method of using the same. The guides are kitchen tools used to manually roll out dough with a rolling pin to a desired uniform thickness. The term “dough” is used in a broad sense herein, and includes, but is not limited to, pastry, cookie dough, biscuit dough, pizza dough, pie pastry or dough, filo pastry, puff pastry, fondant or other icing sheets, and the like. Moreover, the present invention could be used not only in connection with baked food goods, but other goods wherein a soft and relatively malleable material is desired to be manually rolled out to a generally uniform desired thickness.

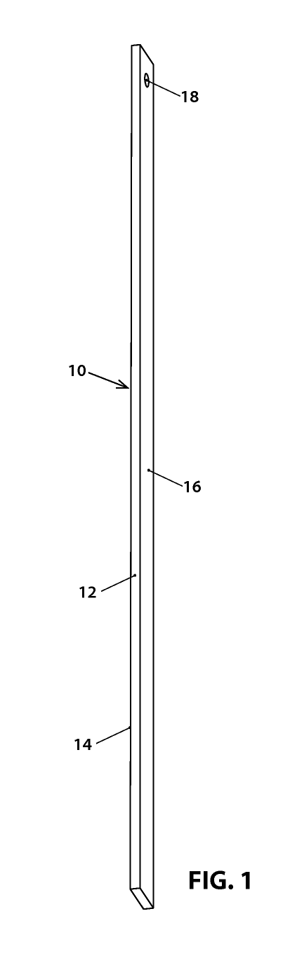

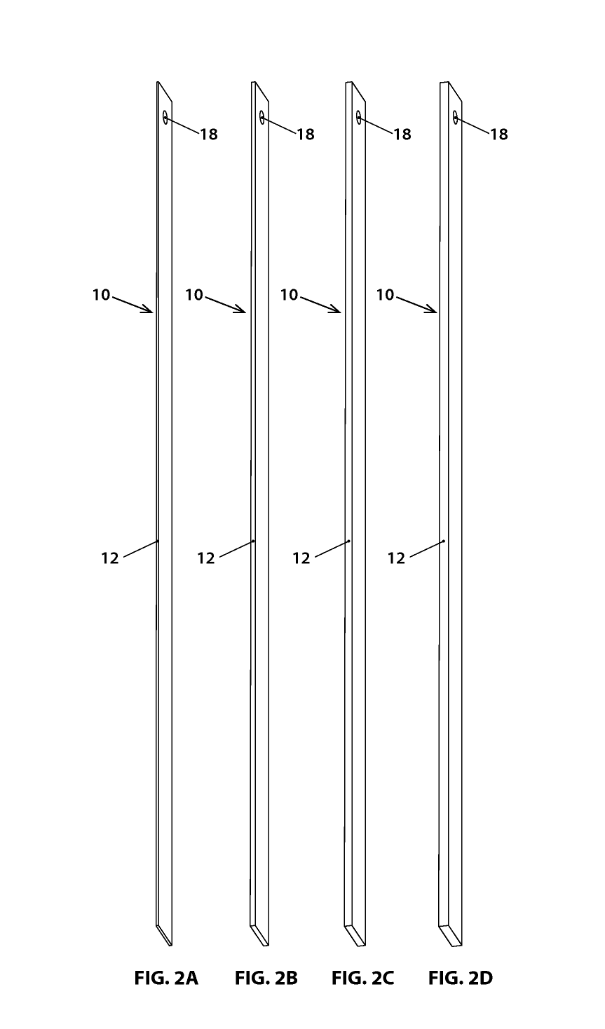

With reference now to FIG. 1, a dough thickness guide and its elongated strip 10 is shown which embodies the present invention. The elongated strips 10 forming the dough thickness guide has generally opposite side edges 12 which are of a predetermined thickness which correspond to the desired thickness of the rolled dough. As can be seen in FIG. 1, the guide strip 10 is of a generally consistent thickness, at least along an operating length thereof. The operating length is the portion of the guide strip 10 upon which the rolling pin is to contact when the desired thickness of the rolled dough has been achieved. Typically, as illustrated in FIG. 1, the guide strip 10 is of generally uniform thickness across its entire length. With reference to FIGS. 2A-2D, four different dough thickness guide strips 10 are illustrated, each having a different thickness, corresponding to the desired thickness of the rolled dough.

Although the guides are typically straight, the configuration thereof can vary. The guide strips 10 are of a sufficient length so as to correspond to a desired dimension of the rolled out dough. The guide strips 10 of the present invention are intended to be used in a variety of settings, and are particularly adapted for use in a residential kitchen. As such, the guide strips 10 are typically within the range of a few inches in length up to twenty-four inches in length. Many baking pans and dishes are less than sixteen inches in diameter or length. Thus, typically the guides are approximately sixteen inches (40.6 cm) in length, in a particularly preferred embodiment. However, it will be appreciated by those skilled in the art that the guide strips 10 may be shorter or longer than sixteen inches. There are instances where the baking dishes or pans may be larger, and the desired length of the guide strips 10 could be provided in a greater length so as to accommodate these dishes. Alternatively, the guide strips 10 can be moved during the dough rolling process.

The width of the guide strips 10 can also vary, but are typically between 0.5 inches to 2.0 inches in width. In a particularly preferred embodiment the guide strips 10 are approximately 0.75 inches in width. The guide strips 10 need only be of a sufficient width so as to provide positive contact with the rolling pin when the dough has been rolled out to the thickness of the guide strips 10, as will be more fully explained herein. As indicated above, it is contemplated by the present invention that the guide strips 10 are of such a dimension so as to be easily used on a typical home countertop and easily stored.

The guide strips 10 have a generally flat lower surface 14 which engages the supporting surface, such as a countertop, upon which the dough is to be rolled. A generally opposite upper surface 16 of the guide strips 10 is also typically generally a flat surface for contacting the rolling pin. It will be understood, however, that the upper surface 16 need not be generally flat, but instead could present a ridge or the like so long as the combined thickness of the height of the ridge to the bottom surface 14 is generally consistent and of a thickness corresponding to the thickness desired of the final rolled dough.

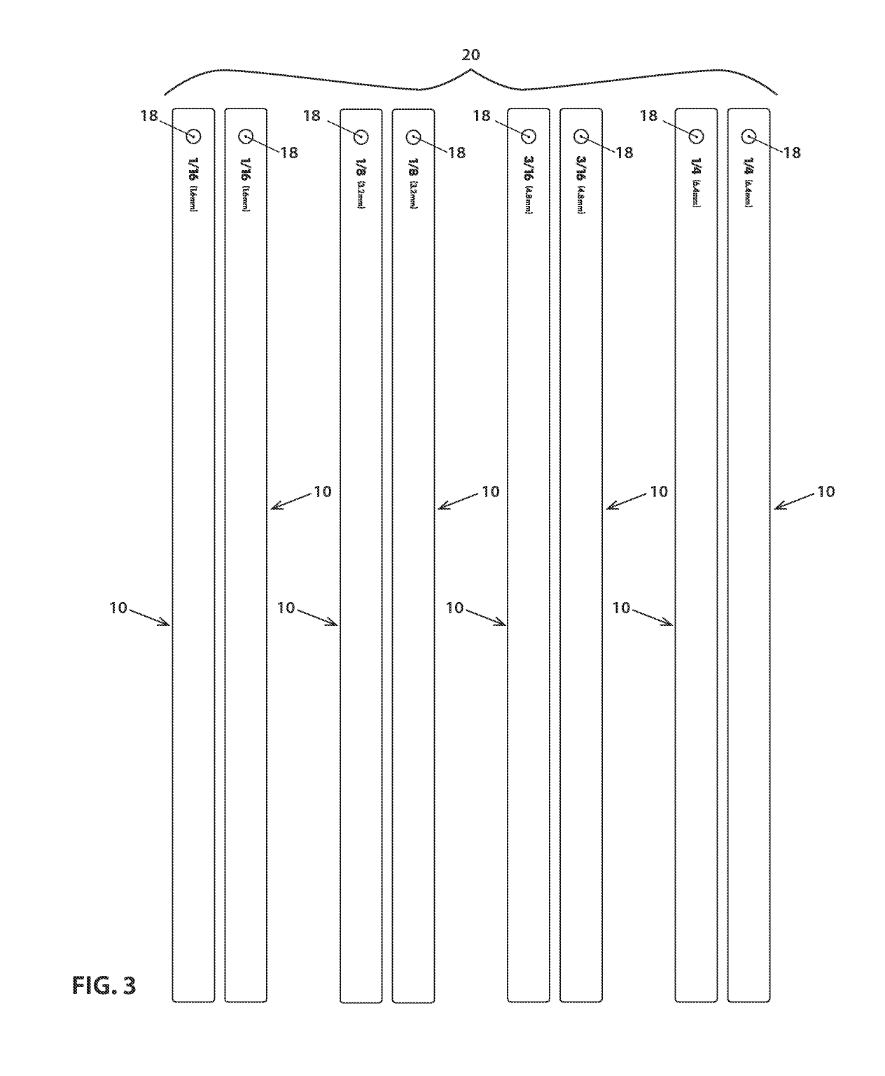

With reference now to FIGS. 2A-2D and FIG. 3, it will be seen in FIGS. 2A-2D that the side edge 12 thickness, corresponding to the thickness of the guide strips 10 is varied so as to enable the user to roll out dough to different thicknesses. Thus, for example, the guide strip 10 illustrated in FIG. 2A is much thinner than the guide strip 10 illustrated in FIG. 2D. This can correspond, for example, to a guide strip 10 having a 1/16 inch (1.6 mm) thickness in FIG. 2A, a ⅛ inch (3.2 mm) thickness in FIG. 2B, a 3/16 inch (4.8 mm) thickness in FIG. 2C, and a ¼ inch (6.4 mm) thickness in FIG. 2D. The thicknesses of the guide strips 10 can vary, but are typically less than ½ inch. Although the guide strips 10 may be of different thicknesses as needed, the four thicknesses indicated above correspond to the typical thicknesses desired of rolled dough when baking pastries and the like.

Although preferably comprised of wood, the guide strips 10 can be comprised of any suitable material, including plastic, metal, glass, Plexiglas, stone, and the like. The material should be sufficiently rigid so as to resist compression so as to maintain the depth or thickness of the guide strip 10 as pressure is applied thereto, such as by a rolling pin, and capable of being adequately cleaned and reused.

With reference now to FIG. 3, the guide strips 10 are offered in at least pairs having the same thickness, and typically having the same overall dimensions. Preferably, the guide strips 10 are labeled in some manner in order to convey to the user the thickness of each guide strip 10, as illustrated in FIG. 3. This may be done by means of imprinting the thickness thereon, embossing the thickness thereon, providing color-coded indicia, etc. As will be more fully described herein, the guide strips 10 are spaced apart from one another, but less than the length of the rolling pin used, such that the dough can be rolled out and when the rolling pin engages both upper surfaces 16 of the spaced apart guide strips 10 then the user knows that the desired thickness of the dough has been achieved, which is consistent along the area of the dough between the guide strips 10.

In a particularly preferred embodiment, an aperture 18 is formed through the guide strip 10 adjacent to an end thereof of a sufficient dimension so as to enable the guide strips 10 to be releasably connected to one another for easy storage.

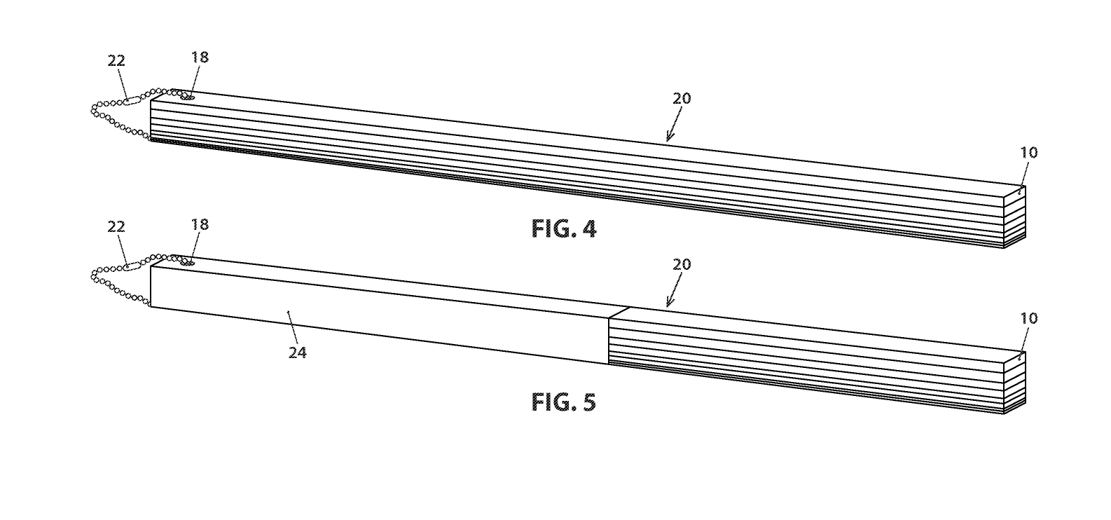

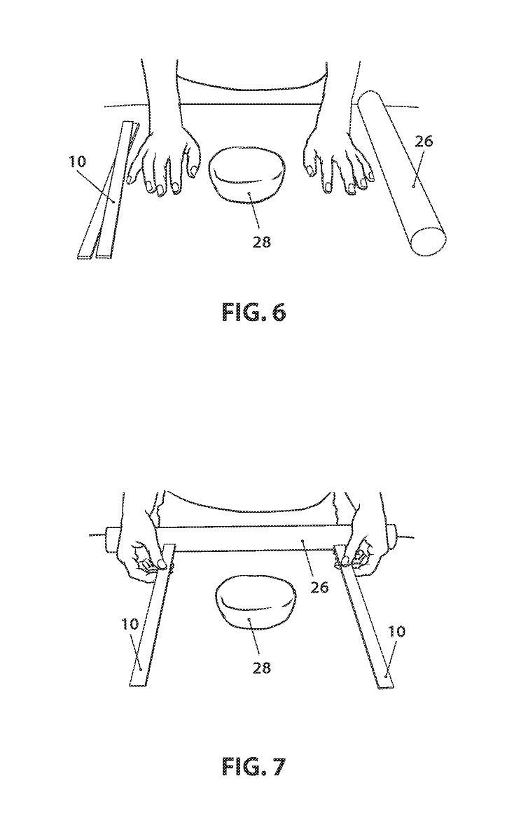

Attached pairs of guide strips 10 as a set 20 is illustrated in FIGS. 4 and 5. It will be seen that a chain 22 extends through the aligned apertures 18 so as to releasably connect the individual guide strips 10 to one another in the set. It will be appreciated that other attachment means, such as a clasp, ring or the like may be used to releasably attach and connect the pairs of guide strips 10 to one another. In a particularly preferred embodiment, the four pairs of guide strips 10 illustrated in FIG. 3 are releasably connected to one another to form a set 20 as illustrated in FIGS. 4 and 5. This allows the pairs of guide strips 10 to be attached to one another for storage when not in use. As shown in FIG. 5, a sleeve 24 may be removably disposed over at least a portion of the aligned guide strips 10, so as to maintain the guide strips in a compact form when stored.

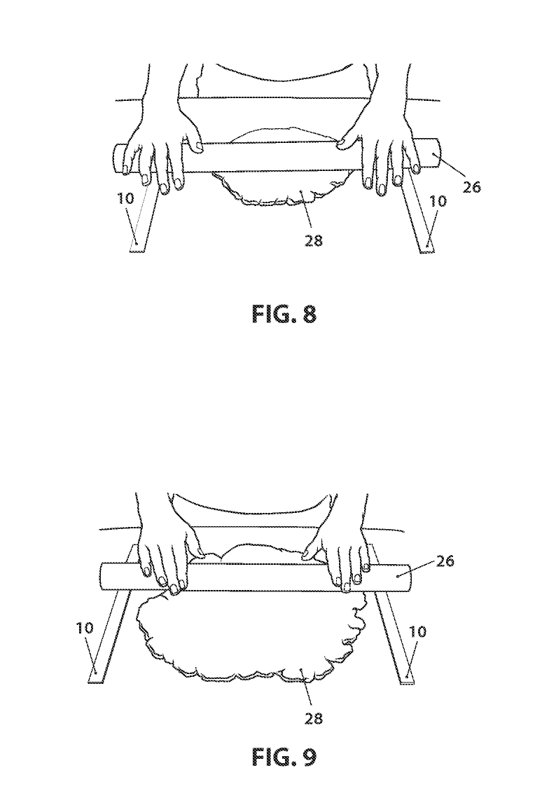

With reference now to FIGS. 6-9, the method of using the guides 10 of the present invention is shown. The method and operation of the guides 10 of the present invention will be described in connection with rolling pastry. Thus, for example, the rolling pin 26 and a supporting surface are dusted, such as with flour, and the pastry dough 28 is placed in the center. Some flour may be dusted onto the pastry dough 28 and/or rolling pin 26 as well to prevent the pastry dough 28 from sticking to the rolling pin 26.

The desired thickness of the dough 28 determines the selection of the guide strips 10. The user removes a pair of dough thickness guide strips 10 having generally the same dimensions and having a thickness corresponding to the desired thickness of the rolled dough from the plurality of dough thickness guide strips detachably connected to one another in the set, as illustrated in FIGS. 4 and 5. Thinner guide strips 10 such as the illustrated 1/16 inch thick guide strips 10 may be used for relatively thin pastries and the like. The most commonly used pastry thickness is ⅛ inch, and the user may select a pair of guide strips 10 corresponding to this thickness. The 3/16 inch guide strips 10 provide a thicker pastry for richer pies, such as apple pie. The ¼ inch guide strips 10 may be used, for example, in creating cookies and the like. Of course, when utilizing the guide strips 10 with other food materials, such as icing or fondant, biscuit dough, bread dough, pizza dough, etc. a different thickness guide strip 10 pair may correspond to the need for such dough.

With reference now to FIG. 7, the guide strips 10 are spaced apart from one another a distance corresponding to less than the length of the rolling pin 26 between the ends thereof. The rolling pin 26 must be able to contact the upper surface 16 of both guide strips 10 in order to ensure that the desired consistent thickness of the dough 28 has been achieved. The guide strips 10 may be placed on either side of the dough, or the dough disposed and placed between the spaced apart guide strips 10 before beginning to be rolled by the rolling pin 26.

As illustrated in FIGS. 5 and 6, the guide strips 10 are spaced apart from one another a distance corresponding to less than the length of the rolling pin 26. The pastry dough 28 is placed between the guide strips 10.

With reference now to FIGS. 8 and 9, the user begins to roll the dough 28, beginning in the middle of the dough and rolling from the center outwards, turning the dough 28 frequently. This is done until the rolling pin 26 reaches the guide strips 10, as illustrated in FIG. 9. Once the rolling pin 26 reaches the guide strips 10 along an entire area of the rolled dough 28, the dough 28 has been rolled to a generally uniform thickness corresponding to the thickness of the guide strips 10.

Thus, for example, if a pastry thickness of one-eighth inch was desired, a pair of one-eighth inch guide strips 10 would be selected and spaced apart from one another no greater than the length of the rolling pin 26. When the pastry dough 28 is fully rolled out to the point where the rolling pin 26 contacts both of the guide strips 10, the pastry dough 28 has been rolled out to a one-eighth inch uniform thickness. This will result in even baking of the pastry or crust.

It will be appreciated that the guide strips 10 of the present invention can be used with any size or type of rolling pin. The rolling pin can be relatively long or relatively short. The rolling pin can be made of wood, marble, metal, etc. Moreover, the rolling pin may be of a “roller” type with handles extending from the ends thereof for grasping and pushing the rolling pin across the dough. In such case, the guides 10 will be spaced apart from one another within the length of the roller portion of the rolling pin.

Although the invention has been described above as providing a pair of guides 10 to be used in the method of creating dough of a desired uniform thickness, it will be appreciated that more than two guides, such as three or four guides, may be placed around the perimeter of the dough to be rolled out. Similarly, a framework of interconnected guides or guides placed adjacent to one another or abutting one another could be used around the perimeter of the dough. The important aspect is that when the rolling pin encounters at least two guides 10, or opposing portions of a framework of a guide the dough therebetween has been rolled to a desired uniform thickness.

After use, the guides 10 may be quickly and easily washed, such as wiping with a damp cloth, and easily stored within a drawer or cabinet of the user's kitchen, until used again in the future. As described above, a clasp or other attachment means may attach guides 10 of the same dimension to one another, or several pairs of different dimensions to one another for storage and easy later retrieval.

Although several embodiments have been described in detail for purposes of illustration, various modifications may be made without departing from the scope and spirit of the invention. Accordingly, the invention is not to be limited, except as by the appended claims.

What is claimed is:

1. Dough thickness guides for manually rolling dough to a desired, consistent thickness, the guides comprising a plurality of elongated strips, each strip having a generally consistent thickness along an operating length thereof, at least a pair of the elongated strips being of the same thickness.

2. The dough thickness guides of claim 1, wherein the elongated strips each have a generally flat surface for contact with a supporting surface.

3. The dough thickness guides of claim 2, wherein an opposite upper surface of each elongated strip has a generally flat surface for contact with a rolling pin.

4. The dough thickness guides of claim 1, wherein the elongated strips have a width of a less than two inches.

5. The dough thickness guides of claim 4, wherein the elongated strips are between four inches and twenty-four inches in length.

6. The dough thickness guides of claim 1, wherein each elongated strip has opposite side edges of a predetermined thickness corresponding with the desired thickness of the rolled dough.

7. The dough thickness guides of claim 1, wherein the plurality of elongated strips comprise a plurality of pairs of elongated strips having generally identical dimensions.

8. The dough thickness guides of claim 7, wherein the plurality of elongated strips are detachably connected to one another.

9. The dough thickness guides of claim 8, including an aperture formed adjacent to an end of each elongated strip, and a clasp for detachably connecting the elongated strips to one another.

10. The dough thickness guides of claim 1, wherein the elongated strips have a thickness of less than 0.5 inches.

11. A method of manually rolling dough to a predetermined, consistent thickness, comprising the steps of:
providing a rolling pin having a length between opposite ends of the rolling pin;
placing a pair of dough thickness guides, comprising elongated strips each having a thickness of the desired thickness of the rolled dough, in spaced relation less than the length of the rolling pin; and
manually rolling dough disposed between the dough thickness guides using the rolling pin until the rolling pin contacts an upper surface of each of the pair of dough thickness guides.

12. The method of claim 11, including the step of removing a pair of dough thickness guides having generally the same dimensions and having a thickness corresponding to the desired thickness of the rolled dough from a plurality of dough thickness guides detachably connected to one another.

13. The dough thickness guides of claim 11, wherein the elongated strips each have a generally flat surface for contact with a supporting surface.

14. The dough thickness guides of claim 13, wherein an opposite upper surface of each elongated strip has a generally flat surface for contact with the rolling pin.

15. The dough thickness guides of claim 11, wherein the elongated strips have a width of a less than two inches.

16. The dough thickness guides of claim 4, wherein the elongated strips are between four inches and twenty-four inches in length.

17. The dough thickness guides of claim 11, wherein each elongated strip has opposite side edges of a predetermined thickness corresponding with the desired thickness of the rolled dough.
